(19) United States
(12) Patent Application Publication
(10) Pub. No.: US 2012/0106181 A1
(43) Pub. Date: May 3, 2012

(54) Automobile panel extension

(76) Inventors: Daniel Anthony DeRouin, Cape Coral, FL (US); Lana DeRouin-Cutler, Cape Coral, FL (US)

(21) Appl. No.: 12/925,885

(22) Filed: Nov. 2, 2010

(51) Int. Cl. B60Q 1/26

(52) U.S. Cl. 362/487

(57) ABSTRACT

The inventive concept is directed to the tail end lights of automobiles. The present automobile tail light is being removed and replace by a new panel extension including a tail light that represents an early model tail light. This conversion takes into account the existing wiring and the new and the replacing panel extension includes wiring and plugs that are merely plugged into the existing wiring of the automobile.

### BACKGROUND OF THE INVENTION

The inventive concept relates to automobile panel extensions especially at the rear ends and more particularly the tail lights. It involves an automobile extension capable of enhancing the automobile rear end by converting the present appearance of the rear end, especially, the light assembly from one appearance to another, for example, an earlier version of a well known car automobile.

### BRIEF DESCRIPTION OF THE INVENTION

According to one embodiment of the inventive concept, an automobile panel extension including a different light assembly is attached to the rear end of the vehicle, especially, the lights in the end of the rear fender. The different light assembly exhibits a different appearance of the vehicle rear end. The conversion takes advantage of the existing light sockets and wires and/or cables but the framing of the new panel extension and the light lenses is different in appearance once the conversion is complete. According to one embodiment of the invention the extension can be attached to the rear end of a Chevrolet 2006-2009 to thereby restyle the rear tail assembly as a retrofit to take on the appearance or the look of a 1955 Chevrolet. This is quite a novel approach to restyling existing vehicles to take on an older look.

### BRIEF DESCRIPTION OF THE DRAWING

FIG. 1 is a complete parts assembly breakdown;

FIG. 2 is a tail amp and backup lamp wire schematic;

FIG. 3 illustrates the mounting hardware to the vehicle body;

FIG. 4 illustrates the back-up lamp plug;

FIG. 5 is a side view of plug shown in FIG. 4

FIG. 6 illustrates the tail lamp and back-up light plugs;

FIG. 7 is the tail lamp plug.

### DETAILED DESCRIPTION OF THE INVENTION

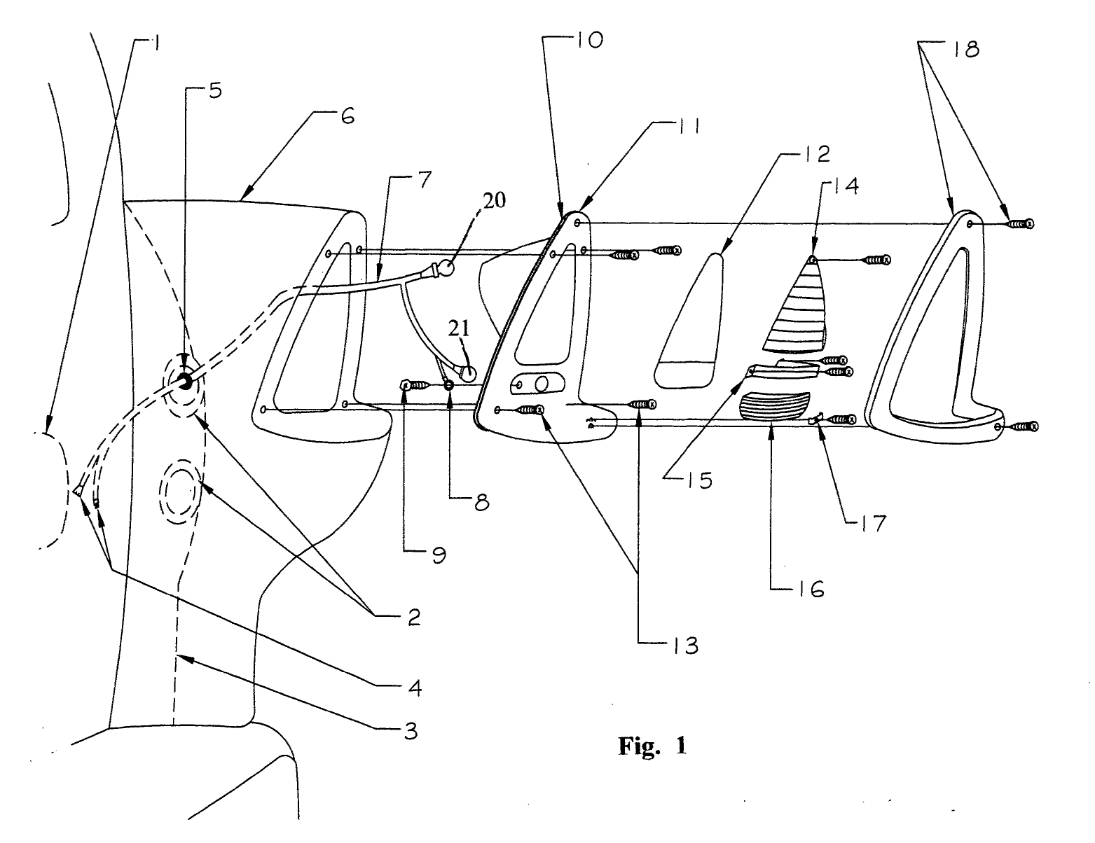

FIG. 1 illustrates the complete parts assembly in a breakdown. There is an interior access door or opening 1 which can gain access to the interior of the rear fender. In addition there are existing tail lamp openings 2 and at 3 there is shown the existing body line of the vehicle. There are two plug connections 4 to which new cables or wires may be attached. There is a grommet 5 that is used to insulate existing wires against chafing or abrading against metal edges. The conversion includes a tail lamp extension 6 including the lamp harness 7 and ground connection 8 to the lamp housing. The housing 11 is attached to the tail lamp extension 6 by way of the screws 9. In between the lamp housing 11 and the extension 6 there is provided a gasket 11 and additionally a lens gasket 12 which is provided between the back-up lens 16 and the red light lens 14. Four screws 13 fasten the housing 11 to the tail lamp extension 6. The tie band 15 is fastened to the lamp housing 11 with two screws (not numbered) including a back-up lens mounting clip 17 with its attending screw. The bracket 18 mounts the back-up lens to the lamp housing 11 by way of the included screws. In FIG. 1, there also shown the existing rear light lamp 20 and the existing back-up lamp 21 which be explained further as the description continues.

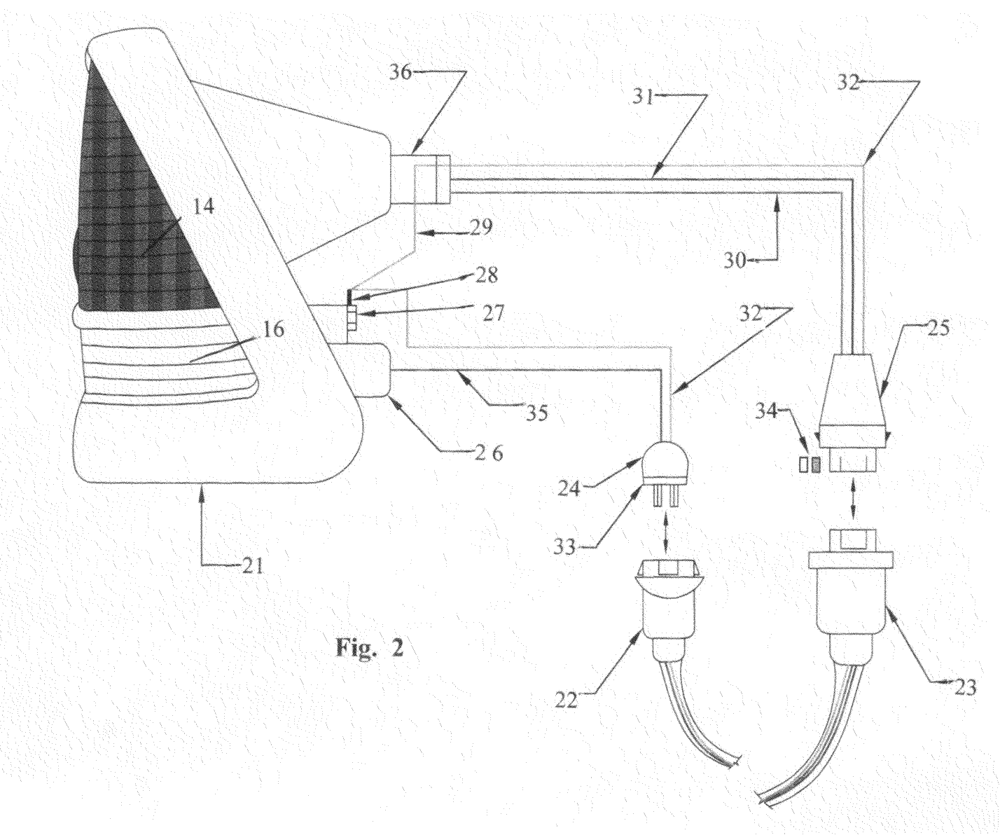

FIG. 2 illustrates the tail lamp and back-up lamp wire schematic. 14 and 16 represent the rear light lens and the back-up lens, respectively. The complete tail lamp assembly is shown at 21 while the corresponding plugs are shown schematically. There is a socket back-up 22 which is existing from the vehicle wiring harness and also the socket 23 of the tail lamp. The plug 24 with its proper color coding 33 will lead the electric power to the back-up lamp 26 and the plug 25 with its color coding 34 will furnish the electric power to the tail lamp. The hex screw 27 will receive the ground 32 (coded green) of the lamp body of the harness by way of the electric connection 28 and also the ground of the 32 (coded green) of the tail lamp socket 36. The blue wire 30 leads to the turn signals and the black wire 35 represents the power wire. Then there is a purple wire 31 which leads to the tail lamp 36. The existing vehicle wiring is identified by the color codes 34 as representing L/S yellow and R/S green.

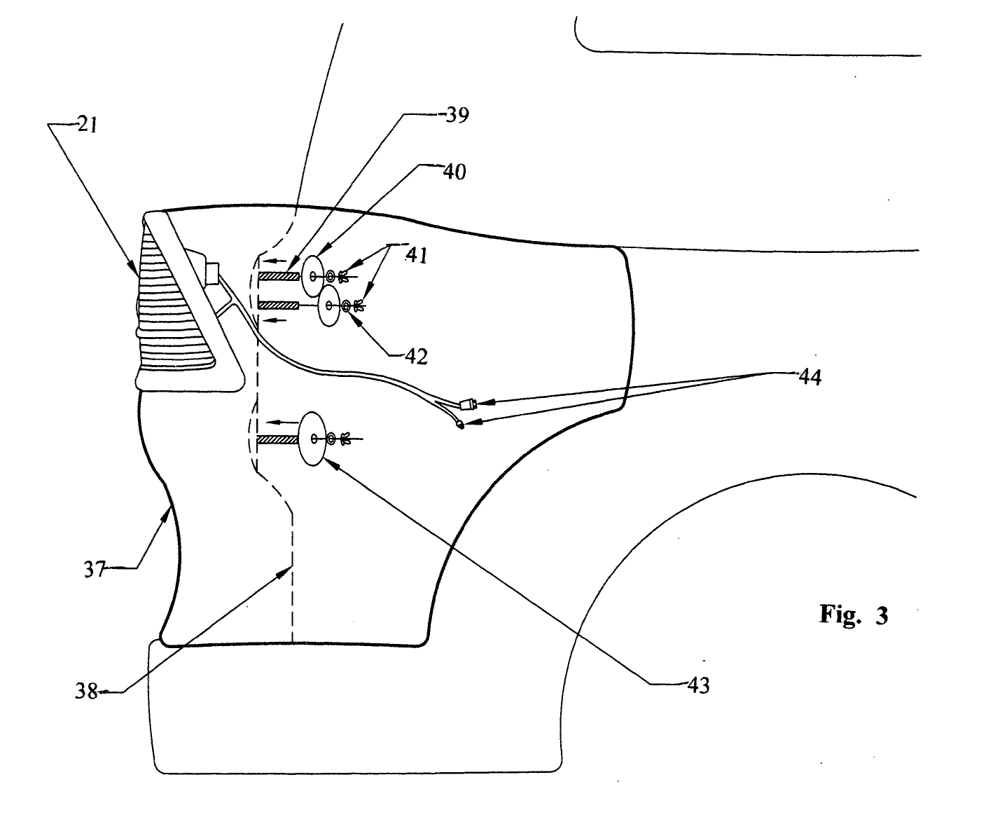

FIG. 3 illustrates the mounting hardware of the inventive panel extension to the existing body of the vehicle. As shown in FIG. 2 as well as in this FIG. 3 the tail lamp assembly is shown at 21 and the fiberglass extension is shown at 37 and the existing vehicle body line is shown at 38. There are long studs (one is shown at 39 which will receive the washers 40 and the respective wing nuts 41 will complete the installation by using the rubber washers 42 under the wing nuts 41. The wiring harness plug 44 will be attached to the existing lines of the vehicle which will further be explained below.

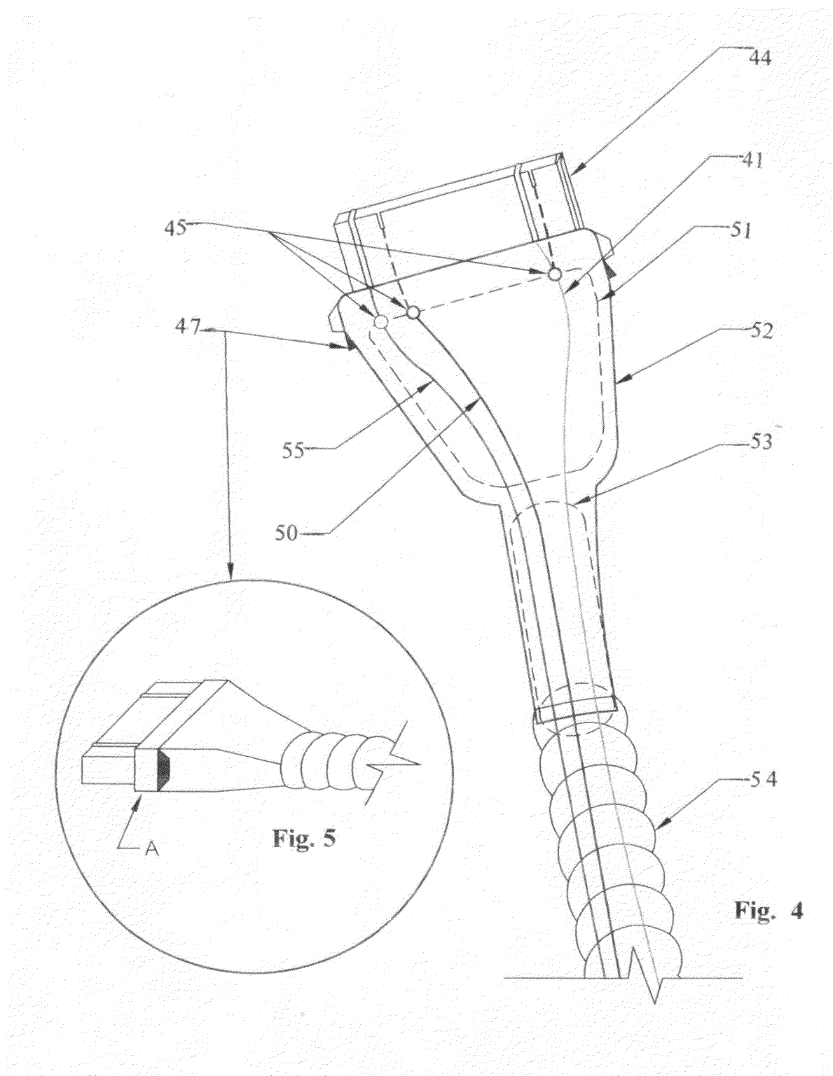

FIG. 4 illustrates the tail lamp plug 44 which is considered the terminal or the end of the plug. The green wire 32 (FIG. 2) is the ground and 45 are the soldered wire points to the plug 44 and 47 represents a color coding mark on the plug 44. At 50 is shown the purple wire which connects to the tail lamp. The female plug 44 is a cap that is filled with fiberglass including the ¾ inch terminal that is heat shrunk around it. At 53 are shown 3 wires that are wrapped in a ¼ inch heat shrink. All of the wires leading into the female plug 44 are contained in common cladding shown at 54.

FIG. 5 shows the color coding on the female plug with A indicating a yellow left side with the green on the right side (not shown).

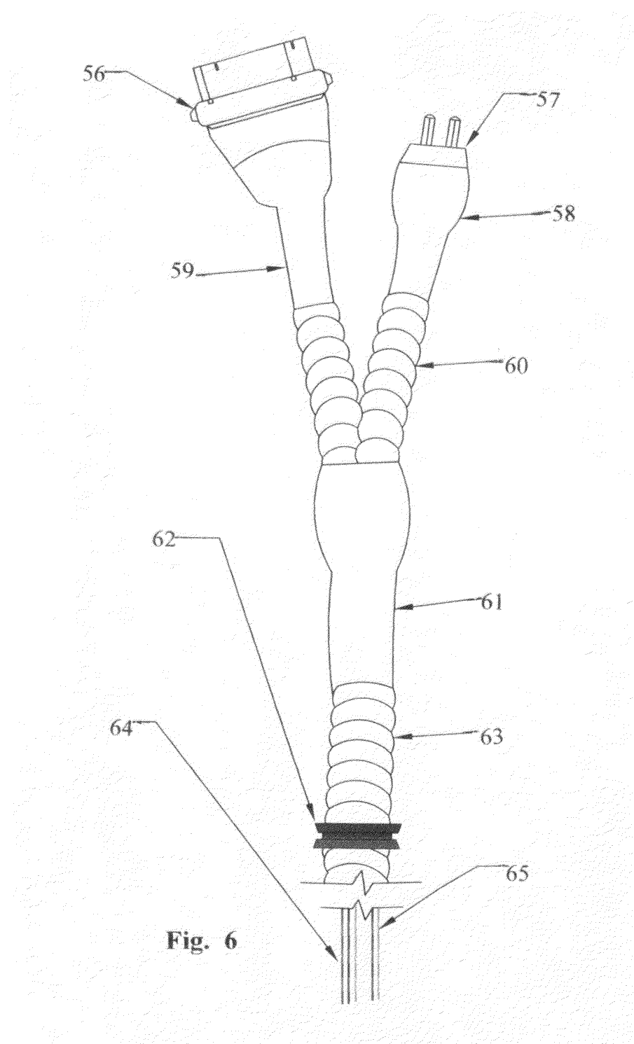

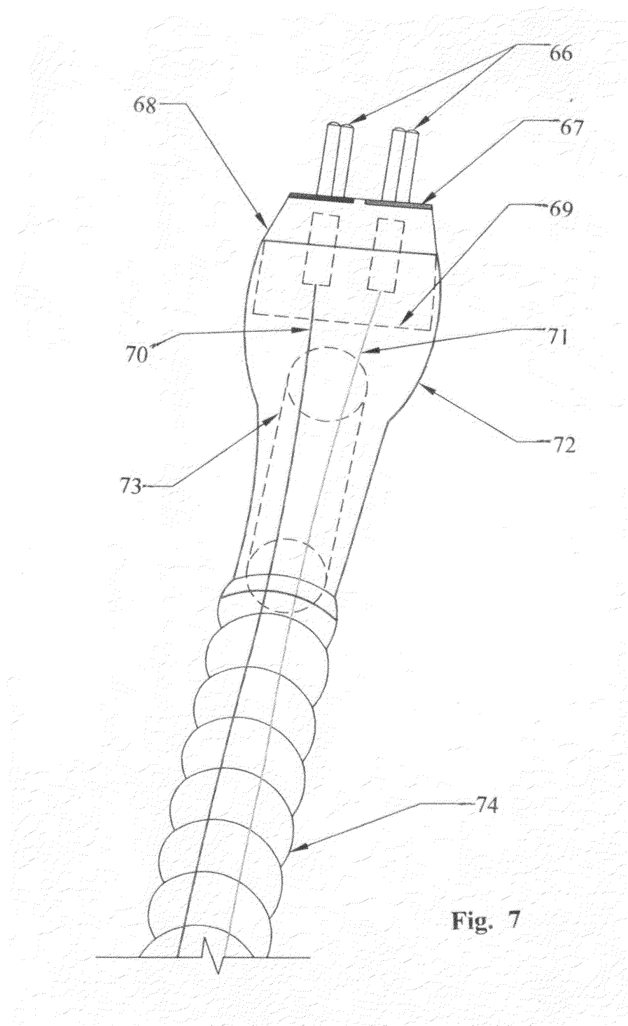

FIG. 6 illustrates the tail lamp and back-up plugs, respectively. At 56 there is shown the female tail lamp plug with color coding (not shown). The male back-up plug is shown at 57 also with color coding (not shown). 58 and 59 represent the heat shrinking of the plugs at ⅜ of an inch 58 and ¾ of an inch 59, respectively. The cladding for the wiring for the male plug 57 is shown at 60 and for both plugs the common cladding is shown at 63. A grommet 62 is shown in the cladding 63 which is used to secure the wiring in a fixed position in the body of the vehicle. To illustrate the different color coding of the wiring harness, at 64 are the wires to the tail lamp as blue for the turn signal and brake, purple to the tail light and green for the ground. The colors cannot be shown in the drawings but are shown in reality when installing the replacement panel extension.

FIG. 7 explains the construction of the male back-up lamp plug. At 66 there shown the two terminal ends of the plug 66 and again at 67 there is shown the appropriate color coding. The plug itself is shown at 68 and 69 shows the terminal cap. The colors cannot be shown in the drawings but in reality the wires are colored and that is 70 in black for the power of the system and 71 green again for the ground. The plug 68 is constructed by heat shrinking the plug to ⅜ of an inch shown at 72 and ¼ A of an inch at 73 for the casing wiring. The overall wires are contained in a cladding 74 which is standard in most automobiles.

From all of the above it now be seen that it is very easy to convert the present existing tail light assembly of an automobile to another appearance to thereby represent early models rear ends on the present automobile. This is easily done by constructing a panel extension including the early model tail light and by removing the present tail light and then to install the new panel extension over the just removed tail light.

What we claim is:

1. A replacement automobile panel extension for the rear quarter panel of a present automobile, said automobile extension panel includes a tail lamp of an earlier model automobile, said panel extension includes wiring to be plugged into the existing wiring of said present automobile.
